(19) United States
(12) Patent Application Publication
(10) Pub. No.: US 2025/0342684 A1
(43) Pub. Date: Nov. 6, 2025

(54) METHOD AND SYSTEM FOR IDENTIFYING GRAIN BOUNDARIES AND MINERALS IN A SAMPLE

(71) Applicant: CGG SERVICES SAS, Massy Cedex (FR)

(72) Inventors: Song HOU, Horsham (GB); Chin Hang LUN, Crawley (GB); Joseph EMMINGS, Willoughby-on-the-wolds (GB)

(21) Appl. No.: 18/870,223

(22) PCT Filed: Apr. 19, 2023
(86) PCT No.: PCT/IB2023/000225

§ 371 Date: Nov. 27, 2024

Related U.S. Application Data
(60) Provisional application No. 63/347,161, filed on May 31, 2022.

(51) Int. Cl. G06V 10/774; G06V 10/141; G06V 10/143; G06V 10/26; G06V 10/42; G06V 10/82; G06V 20/69

(52) U.S. Cl. CPC G06V 10/774; G06V 10/141; G06V 10/143; G06V 10/26; G06V 10/431; G06V 10/82; G06V 20/693

(57) ABSTRACT

A method for generating a training dataset for determining grain boundaries and minerals in a thin section of a rock sample, includes receiving the thin section of the rock sample, generating optical images of the thin section with an optical tool, generating mineral phase images of the thin section with an electron microscopy tool, computing first and second pseudo-images based on different features extracted from the optical images, generating the training dataset based on (1) the optical images, (2) the mineral phase images, and (3) the pseudo-images, and training a single deep neural network, DNN, based on the training dataset to simultaneously determine a mineral type and grain boundaries in the thin section of the rock sample.

### BACKGROUND OF THE INVENTION

### Technical Field

Embodiments of the subject matter disclosed herein generally relate to a system and method for identifying minerals and associated grain boundaries in a given sample, and more particularly, using a neural network to automatically determine the mineral composition and the grain boundaries in a rock sample, based on a single model.

### Discussion of the Background

The identification of minerals, organic matter, pores and grains (comprising one or more discrete minerals or organic phases) in thin sections of a rock sample is a daily occurring task that helps the geologists in understanding key rock properties of that sample, which are relevant for a vast range of applications such as oil and gas exploration, geothermal energy, carbon capture and storage, minerals and mining, engineering and environmental applications. Historically, minerals and grains are often assessed, described, and quantified by manual inspection of thin section images acquired using various techniques such as polarised light or electron microscopy. These tasks require a geologist analysing these samples and using her or his vast expertise for correctly identifying the type of minerals. Even so, a bias of the geologist is present no matter her or his expertise, and thus, sometimes there is no consistent interpretation of the samples from one interpreter to another one.

The analysis employed by the interpreter uses thin sections of the sample, which are thin wafers of the rock (typically 30 μm thick) mounted on glass slides. A light beam is passed through the thin section (transmission) or exposed to the top of the thin section (reflected light). Microscope images (microphotographs) capture the light path passing through or reflecting from the surface of the thin section, through a microscope magnifying objective, into the camera mounted onto the microscope. Plane-polarized light (PPL) and cross-polarized light (XPL), where polarizers are inserted above and below the thin section (at 90° angles), are classic imaging techniques used to determine the minerals in the sample. This well-established technique exploits a key feature of the minerals: different minerals exhibit distinct crystalline structures. Because of these different crystalline structures, the minerals crystals refract the light path in different ways and this is observed under PPL and/or XPL imaging (e.g., Mackenzie, W. S., Adams, A. E., & Brodie, K. H. (2017). Rocks and Minerals in Thin Section: A Colour Atlas (2nd ed.). CRC Press. https://doi.org/10.1201/9781315116365).

Since the mineral crystals are potentially randomly oriented, polarizers can be freely rotated to observe the change in light refraction (birefringence) with respect to the polarization angle. Thus, PPL and XPL images can be acquired as hyperstacks (arrays) of images, each image from the stack potentially containing important information regarding the underlying mineralogy. Also note that different images from the same stack may reveal different features of the same mineral. Circular polarizers and reflected light imaging (including fluorescence imaging) can also be used to provide additional information to diagnose minerals, organic phases and pores present in each sample. Given the vast amount of information which may be obtained from microscopic imaging of rock thin sections, the manual identification of minerals performed by the subject matter expert is tedious, and unfortunately subjective.

In response to these challenges and given the data-rich nature of optical imaging of thin sections, several automatic or semi-automatic approaches have been developed over the years, including the application of machine learning algorithms. For example, [1] used a deep neural network, called LinkNet, to perform semantic segmentation of sandstone grains using XPL and PPL images as input. The authors in [2] developed a two-step method where the initial step is to segment the minerals from the thin section using a clustering algorithm, followed by identification of the minerals using a neural network. The authors in [3] performed semantic segmentation on thin section images via a multilayer perceptron and random forests for a pixel-by-pixel classification. Some approaches only address mineral grain boundaries (rather than mineralogy), such as [4], which used GIS software to detect grain boundaries by analysis of colour intensity amongst the adjacent minerals in sequential XPL images.

Thus, many existing approaches only address part of the problem: either only the identification of the grain boundaries or only the identification of the mineral types via semantic segmentation. Some prior approaches address both tasks but in two separate steps, involving different algorithms. XPL images of the thin section are commonly utilized in many prior approaches, but often only in a simplistic manner as extra input images to the algorithm or machine learning model. Some authors have investigated deriving features from a sequence of XPL images, for instance [5] and [6] computed the minimum and/or maximum pixel value for all pixels over a sequence of XPL images as an input to their grain boundary detection algorithm. However, these simple transformations of the XPL data discards a lot of latent information recorded in XPL image arrays.

Thus, there is a need for a new method and system that is capable of using the full information from the XPL images for determining in a single step both the type of mineral and the grain boundaries associated with these minerals.

### SUMMARY OF THE INVENTION

According to an embodiment, there is a method for generating a training dataset for determining grain boundaries and minerals in a thin section of a rock sample. The method includes receiving the thin section of the rock sample, generating optical images of the thin section with an optical tool, generating mineral phase images of the thin section with an electron microscopy tool, computing first and second pseudo-images (I1, I2) based on different features extracted from the optical images, generating the training dataset based on (1) the optical images, (2) the mineral phase images, and (3) the pseudo-images (I1, I2), and training a single deep neural network, DNN, based on the training dataset to simultaneously determine a mineral type and grain boundaries in the thin section of the rock sample.

According to another embodiment, there is a computing device for generating a training dataset for determining grain boundaries and minerals in a thin section of a rock sample. The device includes an interface configured to receive mineral phase images of the thin section, which are generated with an electron microscopy tool, and receive optical images of the thin section, which are generated with an optical tool, and a processor connected to the interface. The processor is configured to compute first and second pseudo-images (I1, I2) based on different features extracted from the optical images, generate the training dataset based on (1) the optical images, (2) the mineral phase images, and (3) the pseudo-images (I1, I2), and train a single deep neural network, DNN, based on the training dataset to simultaneously determine a mineral type and grain boundaries in the thin section of the rock sample.

According to yet another embodiment, there is a method for simultaneously determining grain boundaries and minerals in a thin section of a rock sample. The method includes receiving the thin section of the rock sample, generating optical images of the thin section with an optical tool, computing first and second pseudo-images (I1′, I2′) based on different features extracted from the optical images, generating a dataset based on (1) the optical images, and (2) the pseudo-images (I1′, I2′), and simultaneously generating mineral phase images and grain boundaries of the thin section of the rock sample, with a trained deep neural network, DNN.

According to still another embodiment, there is a computing device for simultaneously determining grain boundaries and minerals in a thin section of a rock sample. The device includes an interface configured to receive optical images of the thin section, which are generated with an optical tool, and a processor connected to the interface and configured to compute first and second pseudo-images (I1′, I2′) based on different features extracted from the optical images, generate a dataset based on (1) the optical images, and (2) the pseudo-images (I1′, I2′), and simultaneously generate mineral phase images and grain boundaries of the thin section of the rock sample, with a trained deep neural network, DNN.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a first implementation of a convolutional neural network (CNN);

FIG. 2 is a schematic diagram of a second implementation of CNN;

FIG. 3 is a schematic diagram of a single DNN model workflow for both grain boundary segmentation and mineral identification;

FIG. 4 is an example of a brightfield image and FIG. 5 is an image of the corresponding EM (mineral map) image of a small region of a thin section sample;

FIG. 6 is a flow chart of a method for image registration between brightfield (optical) image and the EM image as the two images have different scales;

FIGS. 7A and 7B are the output of the image registration method illustrated in FIG. 6 and they correspond to the optical and EM images, respectively;

FIG. 8 is a flow chart of a method for creating training images for the CNN illustrated in FIGS. 1 and 2;

FIG. 9 illustrates a randomly generated Voronoi diagram;

FIG. 10 illustrates the result of perturbing and smoothing the regions of FIG. 9;

FIG. 11 illustrates the result of adding matrix regions to the gaps in FIG. 10, with the remaining white spaces representing pores between the grains and the matrix;

FIG. 12 illustrates a final synthetic brightfield image that is used for training the CNN;

FIG. 13 illustrates the ground-truth consisting of individual masks for each grain in the synthetic image of FIG. 12;

FIG. 14 is a workflow of a method for determining the grain boundaries and identifying mineral types in a rock sample based on a single deep learning model;

FIGS. 15A to 15C illustrate a model inference on a portion of a real thin section image, with FIG. 15A being a brightfield image, FIG. 15B showing the boundaries between grains as derived from the predicted masks, and FIG. 15C being predicted masks representing different predicted mineral types;

FIGS. 16A to 16C illustrate a post processing step in which FIG. 16A is the input brightfield image, and FIG. 16C is the result of the watershed algorithm using the neural network mineral mask (FIG. 16B) as input; and

FIG. 17 is a schematic diagram of a computing device in which any of the methods and CNN models discussed herein may be implemented.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a method for grain boundary detection and mineral identification with single neural network model that uses at least two different types of input images. However, the embodiments to be discussed next are not limited to two types of images but may be used with more than two types of images. Also, the methods discussed in these embodiments may be used not only for determining the rock characteristics in the oil and gas industry, but the properties of any rock material used in any field, e.g., marine related activities where a floating or non-floating structure needs to be anchored or supported by the ocean bottom.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, the two distinct features of grain boundary detection and mineral identification are performed in one single step using a single neural network. This approach is more efficient both in terms of the model training phase (only one model to tune), but also in the deployed phase as it eliminates overhead due to passing data between different models, and only needs to maintain, monitor, and retrain one single model. Note that the existing approaches use a first model for the grain boundary detection and a second model, different from the first model, for the mineral identification. During usage, these two models need to communicate with each other, which results in a slower response of the overall system, as the processing circuits that host these models have to exchange a considerable amount of information. Thus, according to this embodiment, all the communication between the two models is eliminated as a single model is capable of calculating both desired characteristics.

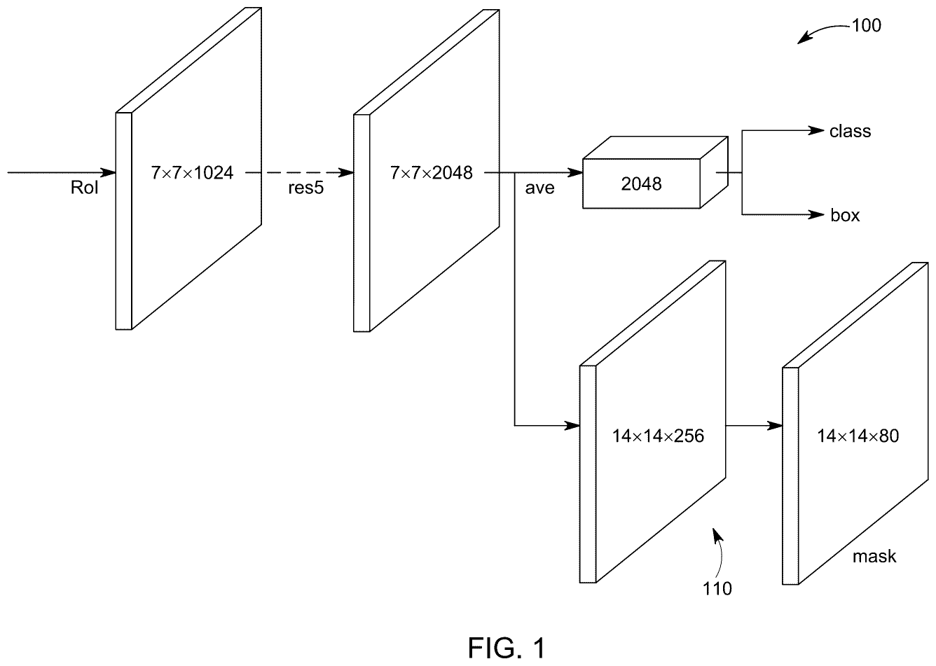

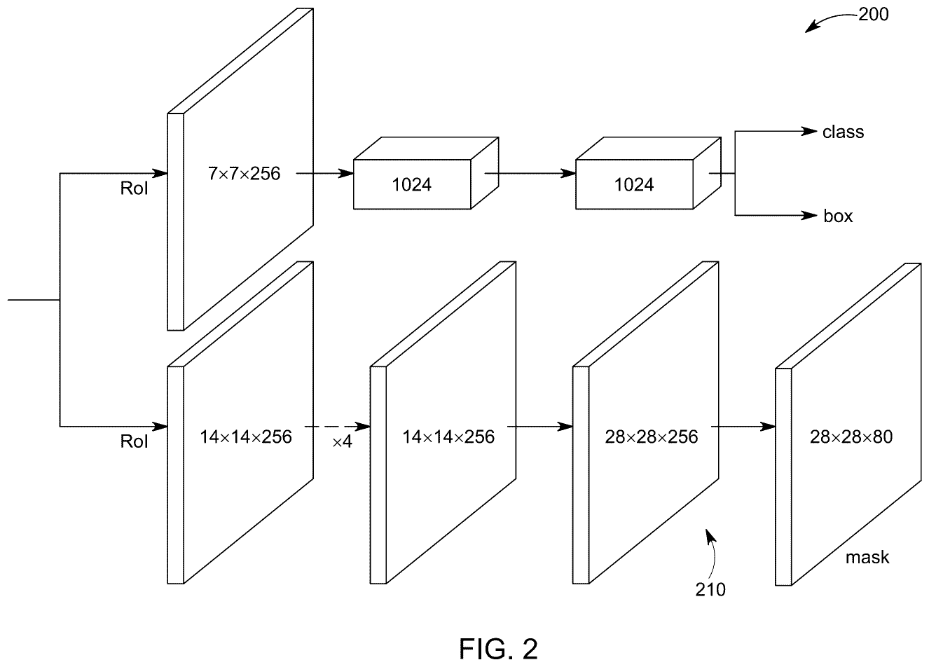

This novel approach considers the problem of grain boundary detection and mineral identification as an instance segmentation task in computer vision, in which a convolutional neural network (CNN) architecture, for example, the Mask R-CNN by [7], is used. FIGS. 1 and 2 illustrate two possible implementations of the architecture of the Mask R-CNN. These figures illustrate the heads 100/200 for the ResNet C4 and FPN backbones, from K. He, X. Zhang, S. Ren, and J. Sun., “Deep residual learning for image recognition,” in CVPR, 2016. 2, 4, 7, 10 and T.-Y. Lin, P. Doll'ar, R. Girshick, K. He, B. Hariharan, and S. Belongie, “Feature pyramid networks for object detection,” in CVPR, 2017. 2, 4, 5, 7, respectively, to which a corresponding mask branch 111/210 is added. The numbers in the figures denote the spatial resolution and channels for each layer of the CNN. The arrows denote either conv, deconv, or fc layers, where conv preserves spatial dimension while deconv increases it. All convs layers are 3×3, except the output conv which is 1×1, the deconvs layers are 2×2 with stride 2, and a ReLU layer is used in the hidden layers. The ‘res5’ in FIG. 1 denotes the ResNet's fifth stage, which was altered so that the first conv operates on a 7×7 Region of Interest (Rol) with stride 1 (instead of 14×14/stride 2). The symbol ‘x4’ in FIG. 2 denotes a stack of four consecutive convs. The examples in FIGS. 1 and 2 are provided to enable one skilled in the art to use the novel concepts discussed herein. However, other CNN implementations may be used.

Whilst this embodiment uses the Mask R-CNN algorithm to perform the task of determining the grain boundary detection and the mineral identification, the approach discussed herein is not restricted to this model; other models are applicable given sufficient training data (as described below). The end-result is a robust grain segmentation coupled to an estimate of the grain mineralogy. This embodiment uses features derived from the XPL images, using, for example, the Fast Fourier Transform (FFT), which better captures the latent information stored in the XPL image arrays. Those skilled in the art would understand that other mathematical processing steps, e.g., tau-p transforms, may be used for this step.

The above discussed neural network requires training. Training neural networks for supervised machine learning requires many labelled training data. Manually labelling thin section images of rock samples is time consuming, especially when the level of detail required in the labels is high due to the many small grains in a typical thin section image. As such, the size of a training dataset that can be produced manually in a reasonable timeframe is small. Thus, the inventors have also developed, in another embodiment, a method of automatically generating training data using a combination of computer vision techniques and outputs of electron microscopy (for example QEMSCAN, which is the name for an integrated automated mineralogy and petrography solution providing quantitative analysis of minerals, rocks and man-made materials). The details of these embodiments are now discussed. For exemplification only, the examples provided herein derive from the analysis of siliciclastic rock materials. However, these embodiments are not limited to siliciclastic materials and they are applicable to other rock types (e.g., carbonates) and granular synthetic materials (e.g., concrete).

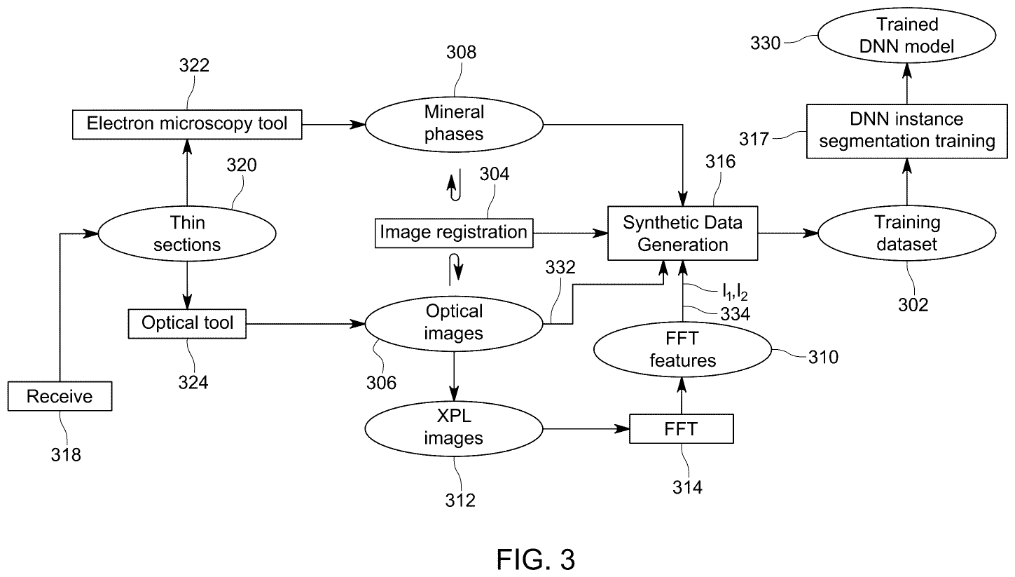

The neural network training embodiment is discussed first. A method for generating training data and training the neural network 100 or 200 includes, as illustrated in FIG. 3, creating a labelled dataset 302 by performing image registration (alignment) 304 between a thin section optical image 306 and its corresponding electron microscopy output 308 to generate a mineral mask. FFT features 310 are computed from the XPL images 312, by applying an FFT operation 314. These features serve as part of the inputs to a synthetic data generation algorithm 316 for creating the dataset 302 for supervised learning. A deep learning model 100/200 is trained, validated, and tested in step 317 on the labelled dataset 302 and the trained model 330 can then be used to make predictions on unseen, unlabelled thin section images.

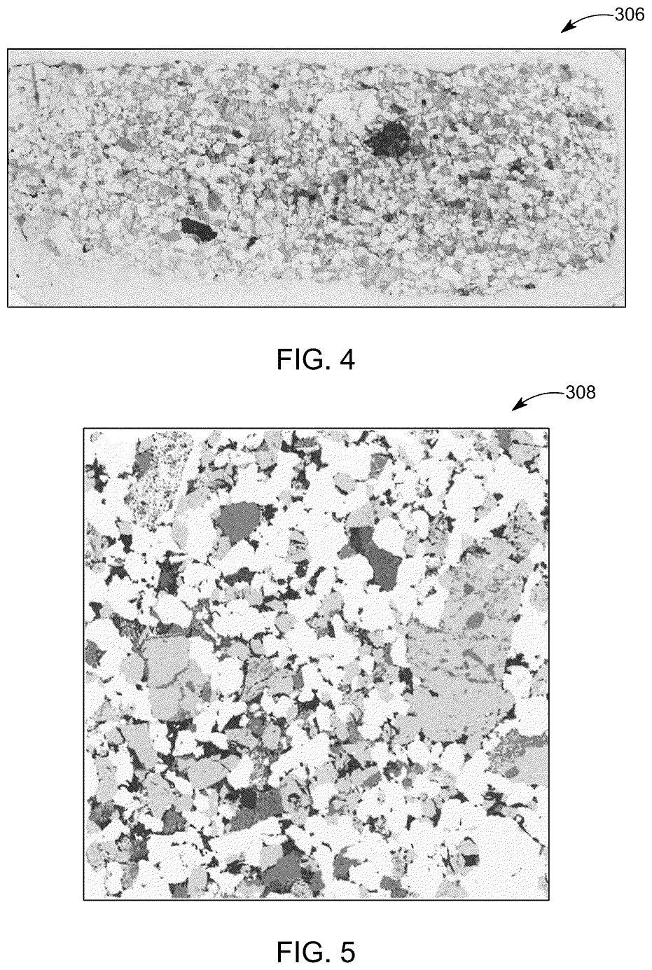

More specifically, thin sections 320 are received in step 318. The thin sections 320 may be received from a client, prepared in a laboratory, or directly from a well location, etc. From the thin sections 320 of a given rock sample, the mineral phase 308 is obtained with electron microscopy tools 322 at a first scale, for example, in the order of micrometers. Other scales may be used. A possible image of the mineral phase 308 is shown in FIG. 5. From the same thin sections 320, optical images 306 are generated in step 324 with optical tools (e.g., optical microscope, or another optical device) at a second scale, for example, in the order of millimeters, different from the first scale. A possible image of the optical images 306 is shown in FIG. 4 and it corresponds to a brightfield image, i.e., an image obtained with a traditional optical microscope. Note that the optical images 306 may include other images, for example, PPL images, XPL images 312, fluorescence images, etc. When comparing FIGS. 4 and 5, it is noted the difference in scale between the two.

The method then performs the image registration step 304, to fit both images 306 and 308 at the same scale. The method also includes a step 314 of applying an FFT to the XPL images 312, and generating in step 316 the synthetic dataset 302 from the optical images 306, the mineral phases 308, and the FFT features 310. In step 317, the deep neural network (DNN) instance segmentation training is applied to the synthetic data 302 to obtain a trained DNN model 330. Some of the steps illustrated in FIG. 3 are now discussed in more detail. With regard to step 304, the optical images 306 of the thin section

samples 320 are captured (for example, using a slide scanner or traditional benchtop microscope) under different optical microscopy illuminations. Imaging options for the step 324 include brightfield microscopy, XPL, PPL, circular polarizer, reflected light and fluorescence microscopy. Fluorescence imaging of rock materials is conventionally performed using UV or short blue incident light with a long pass filter to capture all emission wavelengths. However, the approach in this embodiment is applicable and may be adapted to any excitation and emission wavelengths of interest. Electron microscopy (EM) is performed in step 322, in addition to the optical imaging for each sample 320, to identify the mineral type at each position of the thin section 320.

However, the region of the thin section 320 scanned by the electron microscope at step 322 is only a small portion of the region captured by the optical imaging tool at step 324. Moreover, the optical images 306 and the EM outputs 308 are typically at different scales. Therefore, to use the EM outputs 308 as a mineral mask, the step of image registration 304 needs to be performed. This means that this step finds the region within the optical image 306 that corresponds to the EM image 308 and adjusts the region, for any scale differences, so that the final images (optical and EM) are a match.

One specific way to perform the step of image registration 304 is now discussed. For this example, it is possible to use the brightfield image 306 because the pore spaces in this type of images are more easily identifiable. However, any kind of optical images 306 may be used for this step. Note that the term optical images 306 in this application means at least one image obtained by brightfield microscopy, XPL, PPL, circular polarizer, reflected light and fluorescence microscopy, or other known optical imaging processes. The problem of image registration is a common problem in computer vision and there are established algorithms for it in the computer vision field. However, these computer vision algorithms are intended for situations where the images to be registered are of the same type, for example, both images are optical images, or when the region of overlap between the two images is significant. Both of these assumptions are not true in the present case as the EM image 308 (see FIG. 5) occupies only a small region of the brightfield image 306 (see FIG. 4), and the former is a discrete quantized colour map where different colours correspond to different minerals, whereas the brightfield image is an actual optical image of the thin section 320. For these reasons, the existing computer vision algorithms cannot be directly applied to the image registration step 304.

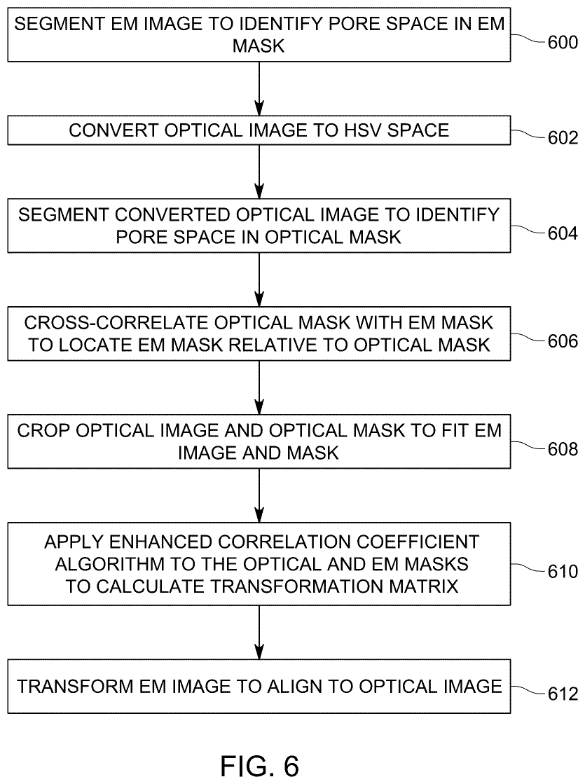

According to this embodiment, and as illustrated in FIG. 6, the image registration 304 first segments the pore spaces from both images to create two binary masks (optical and EM masks) indicating the pixel location of the pore spaces. Note that the term “mask” is known and used in the art of deep learning and essentially refers to an output of prediction of the CNN. For the EM output, because the number of distinct colours in the colour map 308 is limited and known, the pore space is extracted in step 600 (see image registration flow chart illustrated in FIG. 6) by directly using the mapped EM pore spaces (i.e., the EM mask). For the brightfield image 306, it is first converted in step 602 into the hue, saturation, and value (HSV) colour space (to obtain the optical mask), for which it is much easier to select the desired colour in a certain HSV range, and the image is segmented in step 604 to obtain the pore for the optical mask. Note that other colour spaces may be used, for example, the hue, saturation, and brightness (HSB). It is worth noting that this technique of segmenting pore spaces in thin section images is useful, for example, for computing porosities from images.

Next, in step 606, a cross-correlation between the two masks is computed to locate the approximate geo-located position of the EM image 308 with respect to the larger brightfield image 306. The brightfield (image and pore mask) is then cropped in step 608 to fit the smaller EM image 308 and the Enhanced Correlation Coefficient algorithm (a common image registration technique first introduced by G. Evangelidis, E. Psarakis. Parametric Image Alignment Using Enhanced Correlation Coefficient Maximization. IEEE Transactions on Pattern Analysis and Machine Intelligence, 2008, 30 (10), pp. 1858-1865. hal-00864385) is applied in step 610 to the optical and EM masks to calculate the transformation matrix for transforming one image to the other. Finally, in step 612, the EM image 308 is transformed, using the computed matrix, to align it with the cropped brightfield image 306.

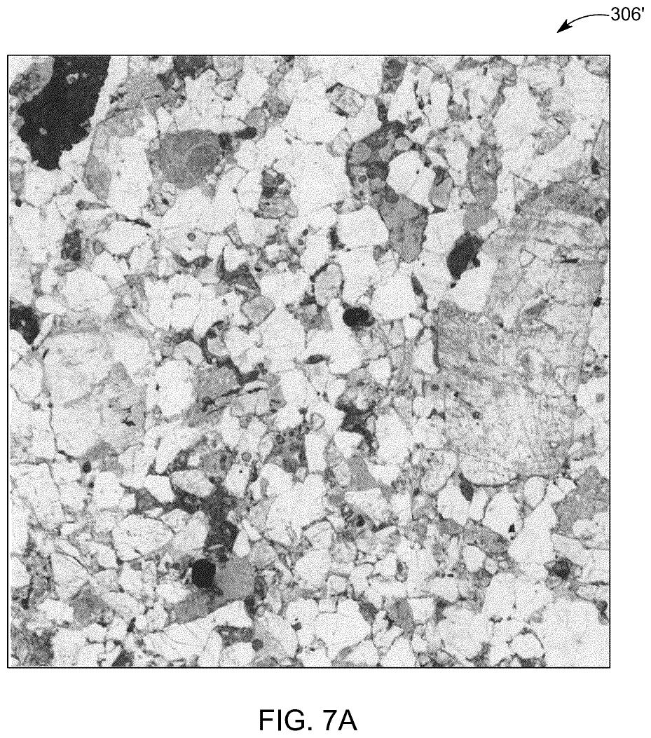

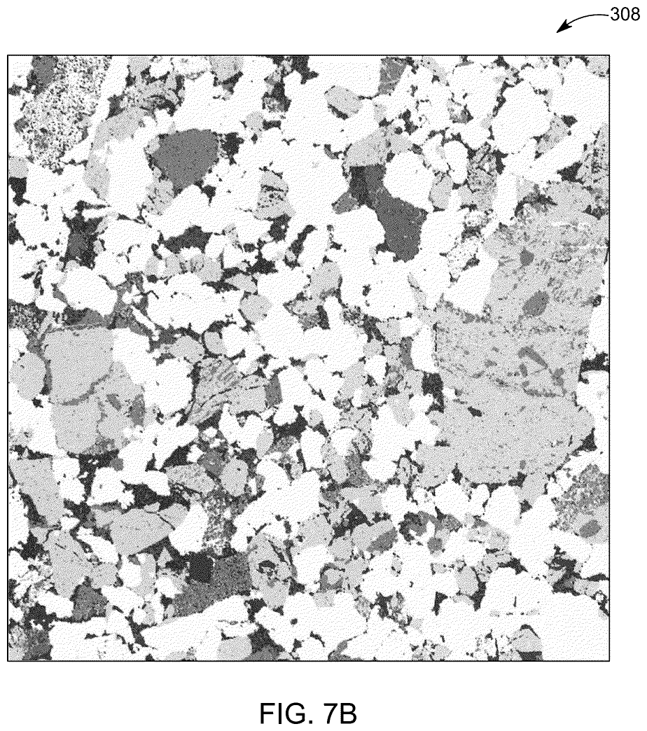

In this respect, FIGS. 4 and 5 show the optical image 306, and the mineral phase image 308 of a same sample, as they are input to the registration step and FIGS. 7A and 7B show the result of the registration step, which here results in a scaling and alignment (rotation in this case) so the two images (adjusted optical image 306′ and original EM image 308) can perfectly overlap.

Next, step 314 introduced above with regard to FIG. 3 is discussed. For this step, also called the FFT feature extraction step, the XPL images 312 are best suited and used in this embodiment. Other types of optical images may also be used as long as it is possible to image the same sample with different angles of polarization. The XPL images 312 form a subset of the optical images 306. The XPL images 312 are a sequence of images of the same sample using light of different angles of polarization. This means, that plural XPL images 312 are used for this method, but all these images correspond to a same sample. Due to the property of birefringence, some minerals in the thin section 320 appear different at different polarizations, in particular their pixel brightness varies as the angle of polarization of the incident light varies. As mentioned above, previous works have experimented with using the minimum or maximum brightness of a pixel over the sequence of images to generate a minimum/maximum image to use it as input in their algorithm. However, this traditional approach discards a lot of information from these images. Therefore, in this embodiment, a FFT transform is used in step 314 to approximate the brightness variation as the angle of polarization (of the incident light) varies for each pixel in the image. The step 314 computes the features 310, i.e., (1) amplitude, (2) frequency, (3) phase and (4) offset of a sinusoid curve that best fits the brightness variation of a same pixel through the stack of XPL images 312. It is noted that the XPL images 312 are taken for different polarization angles, and each of this image, for a same pixel, has a different brightness. Thus, the sinusoid curve describes a variation of the brightness of a given pixel versus the various polarization angles at which the images are acquired. A sinusoid curve may be calculated for each pixel in the XPL images 312. The phase and the other fitted parameters for the pixel are then used to derive two different pseudo-images I1 and I2 (the first pseudo-image I1 is generated based only on the phase of the pixel while the second pseudo-image I2 is generated based on the computed parameters (2), (3) and (4) of the same pixel). These pseudo-images I1 and I2 are then used in step 316 for synthetic data generation. Note that the XPL based images I1 and I2 are part of the synthetic data, in addition to the original XPL images 312, which are also supplied to the synthetic data, as illustrated by the paths 332 and 334 in FIG. 3. The logic behind this novel concept of generating the XPL based pseudo-images I1 and I2 is that the phase (1) exaggerates the difference between the grains while the other three parameters (2) to (4) make the grains of the same mineral appear more similar, which should aid a machine learning model to classify it.

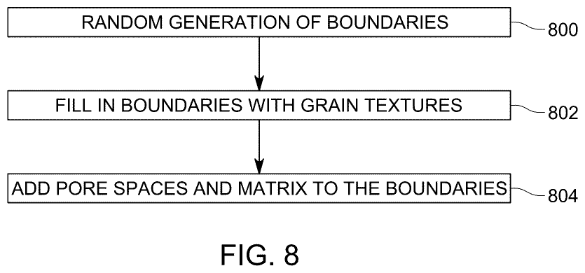

The step of synthetic data generation 316 is now discussed in more detail. The stack of optical images (brightfield, XPL, PPL, circular polarized, fluorescence, etc.) 306, and the FFT computed pseudo-images I1 and I2 from the XPL images are all aligned with the EM output 308. These image layers serve as input to the synthetic data generation step 316. The generation method, which is illustrated in FIG. 8, is split into three parts: a first step 800 of random generation of grain boundaries, a second step 802 of filling in the grain textures inside the generated boundaries, and a third step 804 of the addition of pore spaces and matrix to the generated boundaries. Each of these steps is now discussed in more detail.

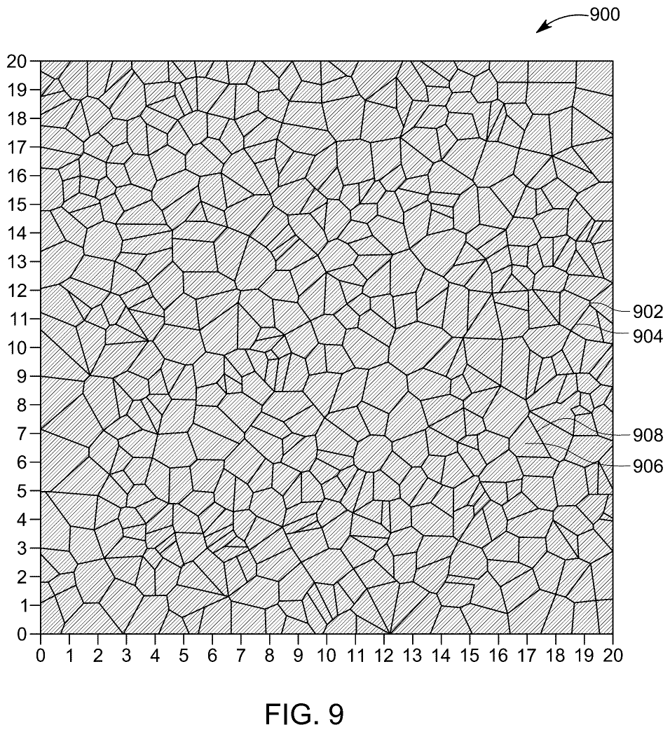

To create the grain boundaries in step 800 for the training data, the method starts with a blank 2D canvas 900 of a certain height and width, on which N points 902 are randomly distributed, as illustrated in FIG. 9. These N points are seeds for creating a Voronoi diagram 904, which partitions the canvas 900 into polygonal regions 906. The purpose is that these regions 906 become the grains in the final image. Because some of the initial points are closer to each other than others, some of the resulting regions will be smaller than others and each region's shape depends on how its neighbouring regions and their corresponding points were distributed. By adjusting N for a fixed height and width, this step can produce images with varying density of grains.

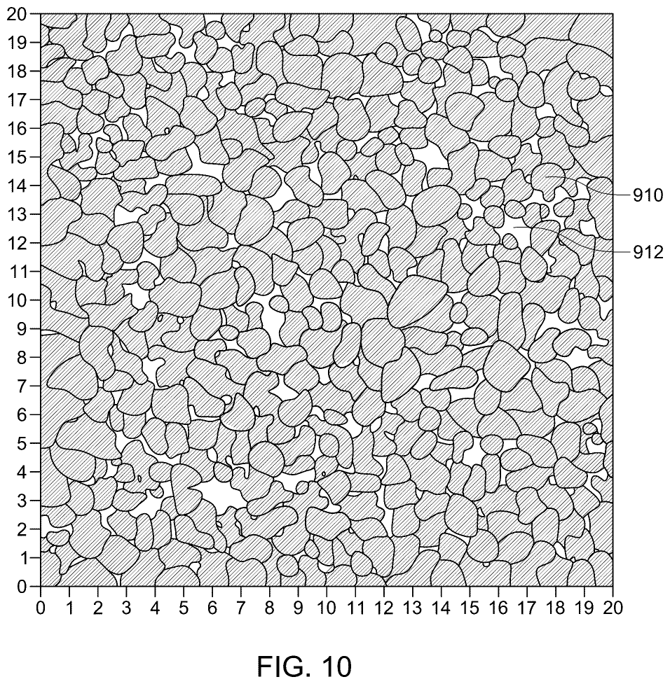

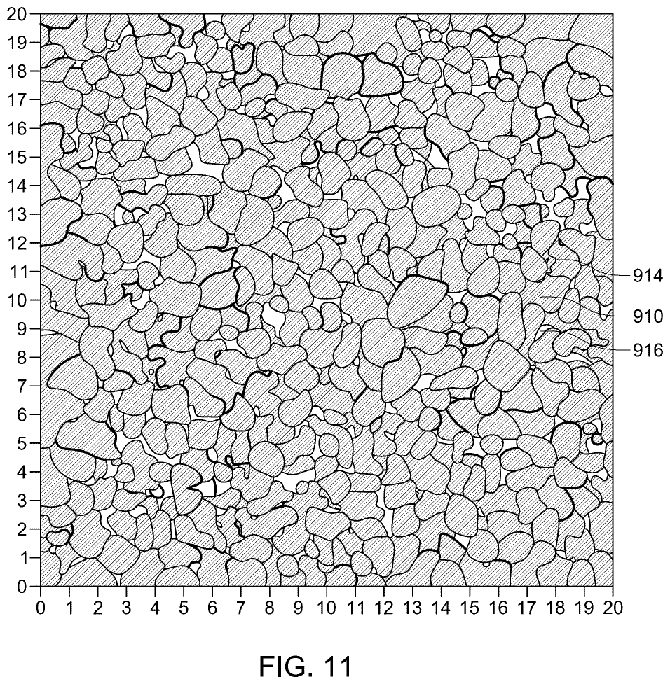

Next, the boundaries of each region 906 are perturbed by distributing on the boundary a set of points 908 (only one shown for simplicity), whose positions are then perturbed in a random direction with a magnitude chosen at random, between a user specified minimum and maximum. The new boundary of the region is obtained by joining each of the perturbed points with a straight line and a smoothing operation is applied to reduce its jaggedness. Finally, overlaps between regions, which have been introduced by the perturbation step, are removed to produce the final grain boundaries 910, as shown in FIG. 10. The process of perturbation and smoothing introduces gaps 912 between the grain regions 910, and these are filled with additional polygons representing matrix regions 914 and any gaps remaining after this step are designated as pore spaces 916 to produce the final image of FIG. 11.

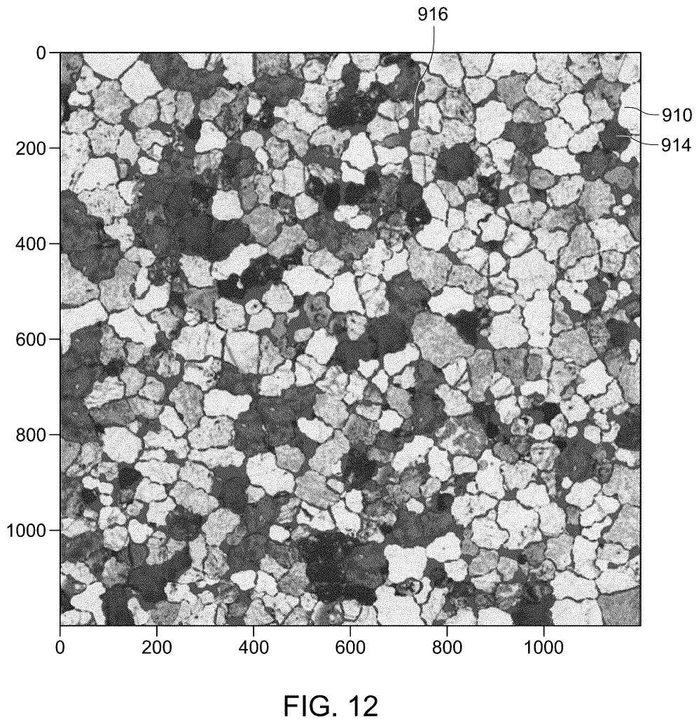

The step 800 produces a collection of grains 910. To make them resemble a real thin section, it is necessary to fill-in the interior of the grains with texture and this needs to be done for every layer of the stack (i.e., for each brightfield, XPL, FFT, etc. image present there). To achieve this goal, a pool of textures is generated for each layer from the aligned images 306 and the EM output 308, the latter of which is used to generate a mask of all pixel location that contains a grain. For each grain of the mask, the largest rectangle that can fit within it is found and this rectangle is used to crop the corresponding region in the optical image 306 or the FFT pseudo-image I1, I2. The result of applying this to every image is a pool of textures of different mineral types. Then, in step 802, for each generated grain 910, (1) a mineral and (2) a sample from the pool of textures, of the right size and mineral type, are randomly selected and pasted to the interior of the grain 910. The same process is applied for the matrix regions 914. The remaining gaps 916 are filled in step 804 with pore spaces, which for the brightfield layer is just filling in the gaps with blue pixels with random noise added in to generate the synthetic image, as shown in FIG. 12.

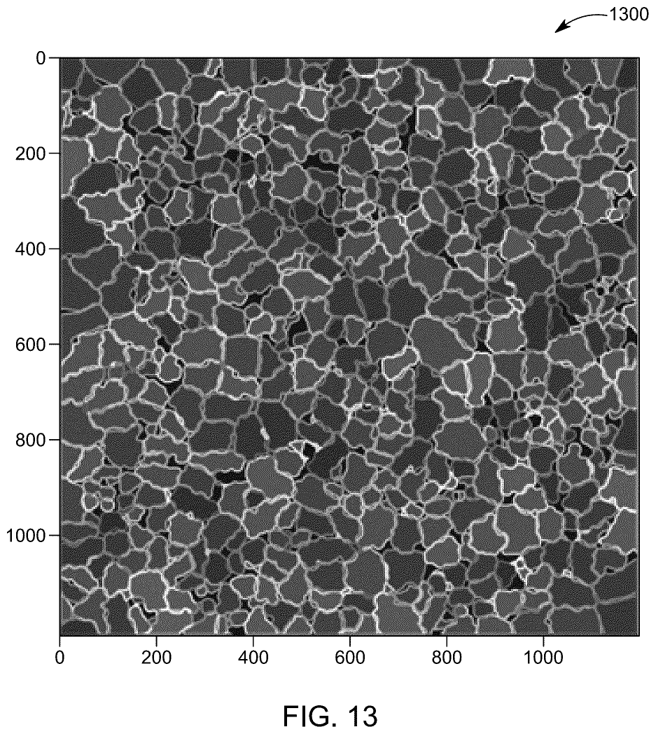

At each step of the generation process, the method keeps track of the boundaries of each grain and their assigned mineral type, so at the end a ground truth grain-by-grain mineral mask 1300 is obtained for model training, an example of which is shown in FIG. 13. The final output of the synthetic data generation step 316 is a collection of training examples 302, where each example consists of a stack of images (optical images 306 and pseudo-images I1, I2) together with the ground truth labels 1300.

Based on this training dataset 302, the selected DNN network 100/200 is trained in step 316 for obtaining the trained DNN model in step 330. More specifically, each optical image 306 is in the order of several thousand pixels long on each side, which is too large for any machine learning model. Moreover, the grains that are desired to be detected in the image are at a much smaller scale to that of the image size. Therefore, in step 316, the input images 302, which include the ground truth 1300, are split into smaller tiles to be fed into the DNN model. This split may be performed at any scale. This step also effectively increases the size of the training dataset 302. In one application, the tiling (i.e., the splitting) can either be uniform, with or without overlap, or each tile can be randomly cropped from the larger image.

In one application, the training dataset 302 was split dataset for training and validation on a sample-by-sample basis, that is the same thin section sample does not appear in both training and validation. For the test set, the method used a separate dataset prepared from a different project to test the model's generalization capability. As for the choice of machine learning model, one embodiment used the Mask RCNN, discussed above with regard to FIGS. 1 and 2. During training, data augmentation, such as flipping and rotating the image, cropping a random region of the image before feeding it to the model, may be applied to help the model generalize.

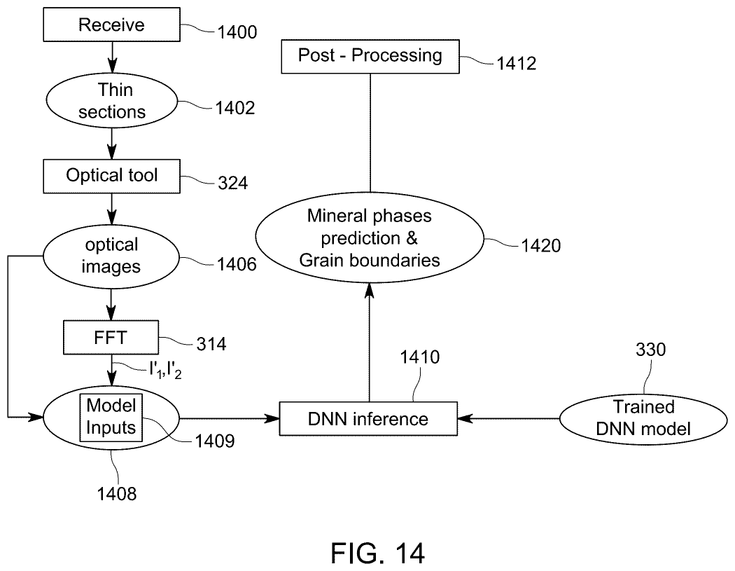

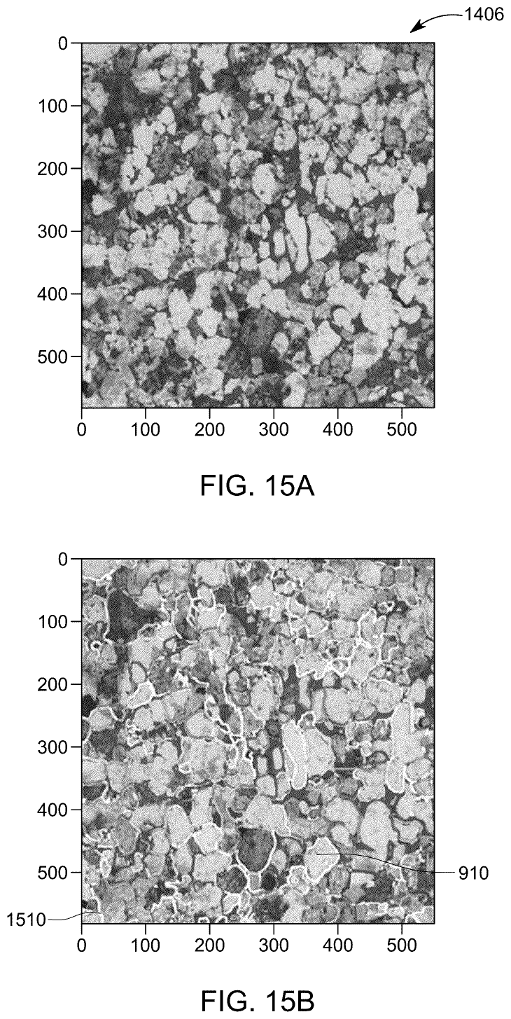

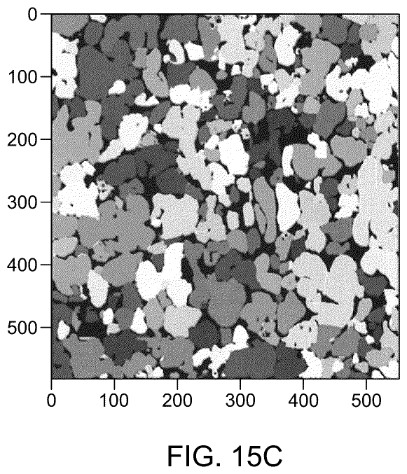

Having the trained DNN model 330, various inferences are made based on it. In order to apply the trained model 330 to new thin section samples 1402, which are received in step 1400 in FIG. 14, microphotograph images 1406 are first captured in step 1404, under different illuminations, in the same way as for the training data discussed in FIG. 3. Similar to training process, each image 1406 is cut into smaller tiles and fed to the trained model 330 for inference, forming the model inputs 1408. Note that the model inputs 1408, used during the inference step 1410, include a stack of images 1409 including the optical images 1406 and FFT pseudo-images I1′ and I2′ obtained from XPL images, as discussed in FIG. 3. The result of the inference step 1410, which is made based on the trained model 330, is a list 1420 of detected grain boundaries with its corresponding mask and the predicted mineral type, as illustrated in FIGS. 15A to 15C. FIG. 15A shows a brightfield image 1406, FIG. 15B shows the boundaries 1510 between the grains 910 as derived from the predicted masks, and FIG. 15C shows the predicted masks with different colours (or shades of grey) representing different predicted mineral types. To mitigate edge effects, the tiles have a small overlap with each other, and for grains lying in the overlapping regions, the method takes the mask prediction with the highest score.

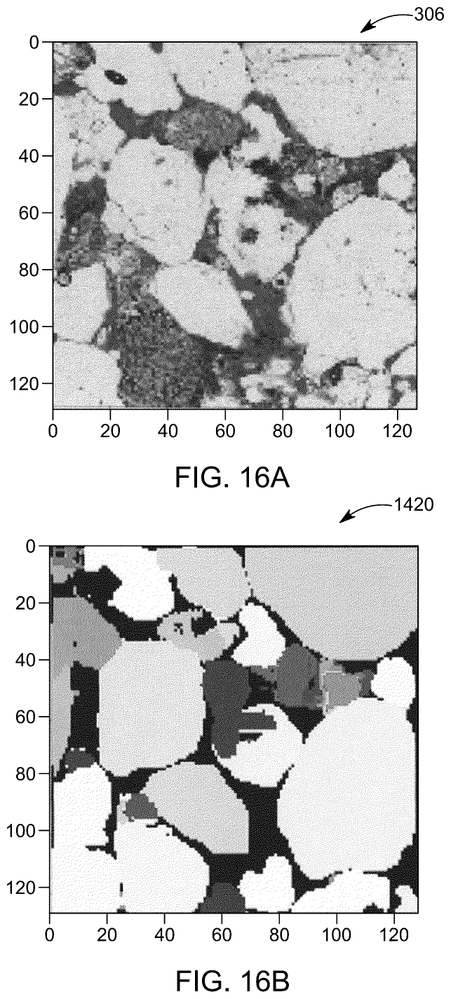

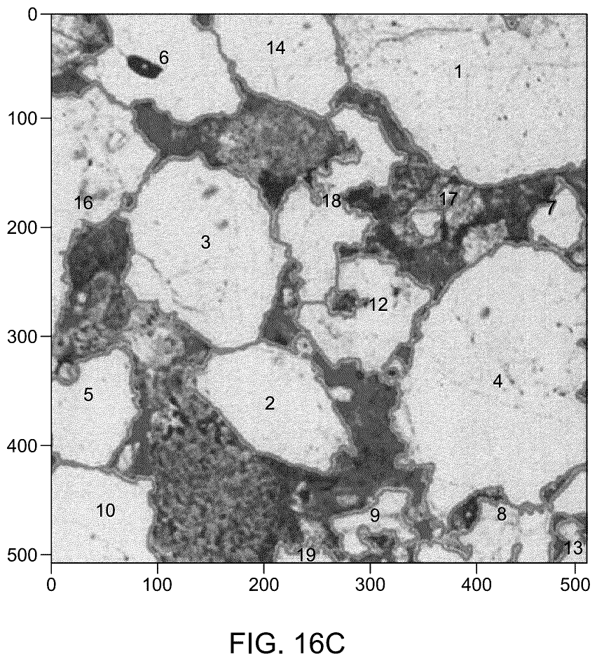

In one application, during a post-processing step 1412, the center of each predicted grain mask is used as a marker for a watershed algorithm, to enhance and augment the grain boundary prediction. The watershed algorithm treats the image it operates upon like a topographic map, with the brightness of each point representing its height, and finds the lines that run along the tops of ridges. Thus, the watershed algorithm is a way of extracting the bright pixels in a grayscale image, which in this case, are the bright pixels corresponding to the quartz grains from the brightfield image 306 shown in FIG. 16A. The watershed algorithm is prone to over-segmentation and so typically the algorithm is initiated with markers indicating the distinct regions which should be merged or not merged. The setting of these markers can be done automatically, using computer techniques like distance transform, but this gives suboptimal results and requires manual intervention depending on the image. Thus, in this embodiment, the center of the predicted quartz grain mask are used as markers for the watershed algorithm to denote the pixel areas which should be kept as a single region. The image 1420 generated by the trained DNN model 330, which is used by the watershed algorithm is shown in FIG. 16B. The result of the watershed algorithm is a robust, high-resolution segmentation for grain boundaries of quartz grains as can be seen in FIG. 16C.

The embodiments discussed above use image hyperstacks spanning a range of different optical imaging techniques as input to the model. FFT is used to extract latent information from the XPL image arrays. To create the training dataset, a technique has been developed for aligning the EM image with its corresponding optical image. EM image outputs are used to automatically generate ground truths for training. This novel step in the training workflow combines and integrates the electron and optical images. In previous work, the grain boundary detection and the mineral classification are two separate steps performed by different algorithms/models. The approach herein uses a single model, trained end-to-end to do both tasks. Finally, a post-processing step using updated seed points from the DNN grain-and-mineral prediction workflow, combined with a classical watershed approach, is an effective, accurate and efficient means to delineate grains on an image-by-image and whole-slide basis.

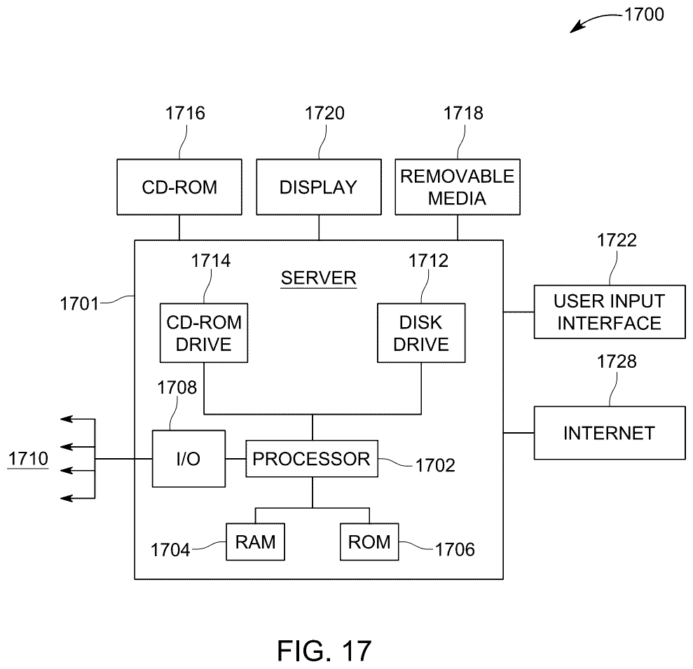

The above-discussed procedures and methods may be implemented in a computing device as illustrated in FIG. 17. Hardware, firmware, software or a combination thereof may be used to perform the various steps and operations described herein. The computing device 1700 is suitable for performing the activities described in the above embodiments and may include a server 1701. Such a server 1701 may include a central processor (CPU) 1702 coupled to a random access memory (RAM) 1704 and to a read-only memory (ROM) 1706. ROM 1706 may also be other types of storage media to store programs, such as programmable ROM (PROM), erasable PROM (EPROM), etc. Processor 1702 may communicate with other internal and external components through input/output (I/O) circuitry 1708 and bussing 1710 to provide control signals and the like. Processor 1702 carries out a variety of functions as are known in the art, as dictated by software and/or firmware instructions.

Server 1701 may also include one or more data storage devices, including hard drives 1712, CD-ROM drives 1714 and other hardware capable of reading and/or storing information, such as DVD, etc. In one embodiment, software for carrying out the above-discussed steps may be stored and distributed on a CD-ROM or DVD 1716, a USB storage device 1718 or other form of media capable of portably storing information. These storage media may be inserted into, and read by, devices such as CD-ROM drive 1714, disk drive 1712, etc. Server 1701 may be coupled to a display 1720, which may be any type of known display or presentation screen, such as LCD, plasma display, cathode ray tube (CRT), etc. A user input interface 1722 is provided, including one or more user interface mechanisms such as a mouse, keyboard, microphone, touchpad, touch screen, voice-recognition system, etc.

Server 1701 may be coupled to other devices, such as seismic sources, microscopy devices, image detectors, etc. The server may be part of a larger network configuration as in a global area network (GAN) such as the Internet 1728, which allows ultimate connection to various landline and/or mobile computing devices.

The disclosed embodiments provide methods and systems for simultaneously identifying, based on a single neural network model, grain boundaries and minerals in thin sections of a rock sample in a consistent manner, independent of the bias associated with a human interpreter. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Das, R., Mondal, A., Chakraborty, T. et al. Deep neural networks for automatic grain-matrix segmentation in plane and cross-polarized sandstone photomicrographs. Appl Intell 52, 2332-2345, 2022.
[2] Hossein Izadi, Javad Sadri, Fateme Hormozzade, Vahidoddin Fattahpour, Altered mineral segmentation in thin sections using an incremental-dynamic clustering algorithm, Engineering Applications of Artificial Intelligence, 90, 2020.
[3] Rafael Andrello Rubo, Cleyton de Carvalho Carneiro, Mateus Fontana Michelon, Rafael dos Santos Gioria, Digital petrography: Mineralogy and porosity identification using machine learning algorithms in petrographic thin section images, Journal of Petroleum Science and Engineering, 183, 2019.
[4] Hassanpour, A, Ali Kananian and Barghi, Minerals Boundary Detection in

Petrographic Thin Sections Image using Arcgis Software, Iranian Journal Of Crystallography and Mineralogy, 17, 2009.
[5] N. Yesiloglu-Gultekin, A. S. Keceli, E. A. Sezer, A. B. Can, C. Gokceoglu, H. Bayhan, A computer program (TSecSoft) to determine mineral percentages using photographs obtained from thin sections, Computers & Geosciences, 46, 2012.
[6] Y. Wen, A Minerals Boundary Enhancement Method in Petrographic Thin Sections Polarization Images, 2019 IEEE 9th International Conference on Electronics Information and Emergency Communication (ICEIEC), 465-468, 2019.
[7] K. He, G. Gkioxari, P. Dollár and R. Girshick, “Mask R-CNN,” 2017 IEEE International Conference on Computer Vision (ICCV), pp. 2980-2988, 2017.

1. A method for generating a training dataset for determining grain boundaries and minerals in a thin section of a rock sample, the method comprising:
receiving the thin section of the rock sample;
generating optical images of the thin section with an optical tool;
generating mineral phase images of the thin section with an electron microscopy tool;
computing first and second pseudo-images (I1, I2) based on different features extracted from the optical images;
generating the training dataset based on (1) the optical images, (2) the mineral phase images, and (3) the pseudo-images (I1, I2); and
training a single deep neural network, DNN, based on the training dataset to simultaneously determine a mineral type and grain boundaries in the thin section of the rock sample.

2. The method of claim 1, wherein the step of generating optical images comprises:
generating cross-polarized light, XPL, images with polarized light; and
generating brightfield images using normal light.

3. The method of claim 2, wherein the step of computing comprises:
computing the first and second pseudo-images only from the XPL images.

4. The method of claim 3, wherein the step of computing further comprises:
applying a Fast Fourier Transform, FFT, to the XPL images;
finding, for each pixel, a sinusoid curve that best fits a brightness of the pixel through the XPL images, versus a polarization of the XPL images; and
calculating the different features as being an amplitude, frequency, phase and offset of the sinusoid curve.

5. The method of claim 4, further comprises:
generating the first pseudo-image based exclusively on the amplitude; and
generating the second pseudo-image based only on the frequency, phase and offset of the sinusoid curve.

6. The method of claim 1, further comprising:
receiving actual images of a new rock sample;
generating new optical images from the new rock sample;
generating new pseudo-images from the new optical images;
running once the DNN, on the new optical images and the new pseudo-images, to simultaneously generate grain boundaries and associated mineral phases of the new rock sample.

7. The method of claim 1, wherein the optical images have a different scale than the mineral phase images.

8. The method of claim 7, further comprising:
applying image registration to the optical images and the mineral phase images; and
cropping the optical images to have a same scale as the mineral phase images.

9. The method of claim 1, wherein the step of generating the training dataset comprises:
randomly generating a Voronoi diagram on a blank 2-dimensional canvas;
perturbing boundaries of the Voronoi diagram in a random direction with a random magnitude to generate perturbed regions;
removing overlaps between the perturbed regions to form grains;
filling the grains with a mineral type and texture randomly selected, wherein the texture corresponds to mineral types; and
filling gaps with blue pixels with random noise to obtain the training dataset.

10. The method of claim 9, wherein the texture is obtained from the (1) the optical images, (2) the mineral phase images, and (3) the pseudo-images (I1, I2).

11. A computing device generating a training dataset for determining grain boundaries and minerals in a thin section of a rock sample, the device comprising:
an interface configured to,
receive mineral phase images of the thin section, which are generated with an electron microscopy tool, and
receive optical images of the thin section, which are generated with an optical tool; and
a processor connected to the interface and configured to,
compute first and second pseudo-images (I1, I2) based on different features extracted from the optical images;
generate the training dataset based on (1) the optical images, (2) the mineral phase images, and (3) the pseudo-images (I1, I2); and
train a single deep neural network, DNN, based on the training dataset to simultaneously determine a mineral type and grain boundaries in the thin section of the rock sample.

12. The device of claim I1, wherein the processor is further configured to:
receive actual images of a new rock sample;
generate new optical images from the new rock sample;
generate new pseudo-images from the new optical images;
run once the DNN, on the new optical images and the new pseudo-images, to simultaneously generate grain boundaries and associated mineral phases of the new rock sample.

13. A method for simultaneously determining grain boundaries and minerals in a thin section of a rock sample, the method comprising:
receiving the thin section of the rock sample;
generating optical images of the thin section with an optical tool;
computing first and second pseudo-images (I1′, I2′) based on different features extracted from the optical images;
generating a dataset based on (1) the optical images, and (2) the pseudo-images (I1′, I2′); and
simultaneously generating mineral phase images and grain boundaries of the thin section of the rock sample, with a trained deep neural network, DNN.

14. The method of claim 13, wherein the trained DNN is trained with a training dataset generated based on (i) previous optical images, (ii) mineral phase images, and (iii) previous pseudo-images (I1, I2).

15. The method of claim 14, further comprising:
computing the previous pseudo-images based on previous different features extracted from the previous optical images;
generating a training dataset based on (i) the previous optical images, (ii) the mineral phase images, and (iii) the previous pseudo-images (I1, I2); and
training the DNN based on the training dataset to simultaneously determine a mineral type and grain boundaries in the thin section of the rock sample.

16. The method of claim 15, wherein the step of generating the previous optical images comprises:
generating cross-polarized light, XPL, images with polarized light; and
generating brightfield images using normal light.

17. The method of claim 16, further comprising:
computing the previous pseudo-images only from the XPL images;
applying a Fast Fourier Transform, FFT, to the XPL images;
finding, for each pixel, a sinusoid curve that best fits a brightness of the pixel through the XPL images, versus a polarization of the XPL images; and
calculating the previous different features as being an amplitude, frequency, phase and offset of the sinusoid curve.

18. The method of claim 17, further comprising:
calculating a first previous pseudo-image based exclusively on the amplitude; and
calculating a second previous pseudo-image based only on the frequency, phase and offset of the sinusoid curve.

19. A computing device for simultaneously determining grain boundaries and minerals in a thin section of a rock sample, the device comprising:
an interface configured to receive optical images of the thin section, which are generated with an optical tool; and
a processor connected to the interface and configured to,
compute first and second pseudo-images (I1′, I2′) based on different features extracted from the optical images;
generate a dataset based on (1) the optical images, and (2) the pseudo-images (I1′, I2′); and
simultaneously generate mineral phase images and grain boundaries of the thin section of the rock sample, with a trained deep neural network, DNN.

20. The system of claim 19, wherein the trained DNN is trained with a training dataset generated based on (i) previous optical images, (ii) mineral phase images, and (iii) previous pseudo-images (I1, I2).
